(19) United States
(12) Patent Application Publication
(10) Pub. No.: US 2019/0008200 A1
(43) Pub. Date: Jan. 10, 2019

(54) LOW VISCOSITY, HIGH CALORIC DENSITY NUTRITIONAL COMPOSITIONS

(71) Applicant: Abbott Laboratories, Abbott Park, IL (US)

(72) Inventors: Kelley LOWE, Powell, OH (US); Timothy CHAPMAN, Grove City, OH (US); Normanella DEWILLE, Columbus, OH (US); Paul JOHNS, Columbus, OH (US)

(21) Appl. No.: 16/064,771

(22) PCT Filed: Dec. 19, 2016
(86) PCT No.: PCT/US2016/067539

§ 371 Date: Jun. 21, 2018

Related U.S. Application Data
(60) Provisional application No. 62/271,625, filed on Dec. 28, 2015.

(51) Int. Cl. A23L 33/00; A23L 33/185; A23L 33/19; A23L 33/115

(52) U.S. Cl. CPC A23L 33/40; A23L 33/185; A23V 2002/00; A23L 33/115; A23L 33/19

(57) ABSTRACT

Liquid nutritional compositions including both soy protein and dairy protein demonstrate enhanced rheological properties. By suitable selection of the types and amounts of these proteins, high caloric density products can be obtained without adversely affecting other desirable properties such as nutritional value, stability, taste, and mouthfeel.

### FIELD

The present disclosure relates to nutritional compositions. More particularly, the present disclosure is in the field of high caloric density nutritional compositions comprising protein from more than one source.

### BACKGROUND

Nutrition shakes, i.e., non-carbonated liquid nutritional compositions that are intended for oral consumption and therefore have the consistency, flavor, and overall desirable sensory characteristics of common every-day milk shakes are widely available consumer products. Examples include the Ensure®, Glucerna®, Myoplex®, and Pediasure® line of nutrition shakes available from Abbott Nutrition of Columbus, Ohio, the Muscle Milk® line of nutrition shakes available from CytoSport, Inc. of Benicia, Calif., and the Resource® line of nutrition shakes available from Nestle, S. A. of Vevey, Switzerland. Generally, they contain balanced amounts of macronutrients (proteins, fats, and carbohydrates), as well as micronutrients and flavorings, and are made up in the form of oil-in-water emulsions having the consistency of common every-day milk shakes.

Certain vegetable proteins may be used as part of the protein component of such compositions. Soy protein is especially preferred, due to its relatively low cost, agreeable texture, and faint flavor. However, experience has shown that inclusion of soy protein can present difficulties in maintaining the overall desirable characteristics of the nutritional shake such as taste, texture, mouthfeel, and stability that consumers have come to expect. Accordingly, the challenge in using soy protein as a component in such a composition is not merely replacing a portion of the composition's existing protein with soy protein, but rather doing so in a way which does not adversely affect its other desirable properties.

### SUMMARY

In accordance with the general inventive concepts, it has been found that by selecting a particular combination of proteins (e.g., particular dairy protein and soy protein) and formulating them in a nutritional composition, it is possible to manufacture a liquid nutritional composition that maintains the taste, texture, mouthfeel, and stability that consumers demand.

In a first exemplary embodiment, a liquid nutritional composition is provided. The liquid nutritional composition comprises a source of soy protein and a source of dairy protein, wherein the liquid nutritional composition has a viscosity of 50 cps to 75 cps and a total protein content of 7 g/100 mL to 20 g/100 mL of the liquid nutritional composition.

In a second exemplary embodiment, a high caloric density liquid nutritional composition is provided. The liquid nutritional composition comprises fat, carbohydrate, and a protein content of 7 g/100 mL to 20 g/100 mL of the liquid nutritional composition. The protein comprises a source of soy protein and a source of dairy protein. The liquid nutritional composition has a caloric density of greater than 1.6 kcal/mL, a viscosity of 50 cps to 75 cps, and wherein the soy protein is present in an amount of 10% to 40% by weight.

### BRIEF DESCRIPTION OF THE DRAWINGS

FIG. 1 is a graph showing the measured change in viscosity relative to soluble calcium in three exemplary liquid nutritional compositions.

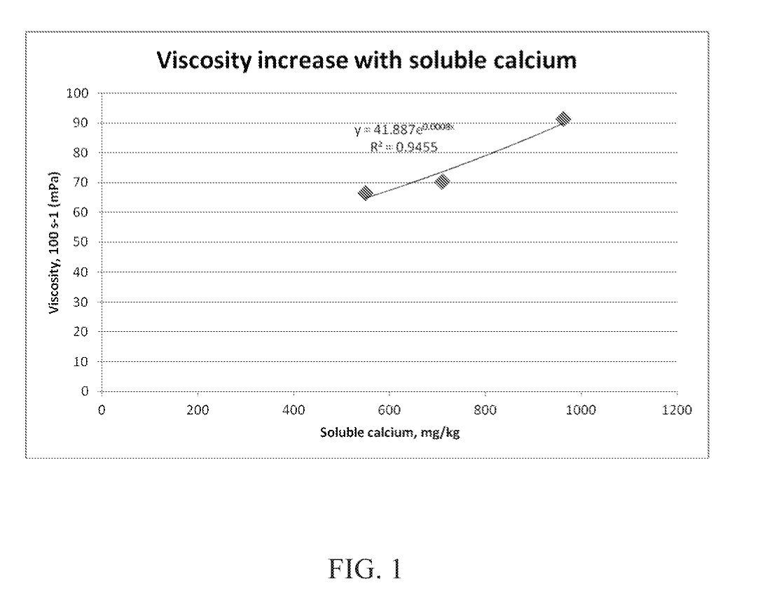

FIG. 2 is a graph showing the pellet weight of three exemplary liquid nutritional compositions, after centrifugation, with variable amounts of soy protein.

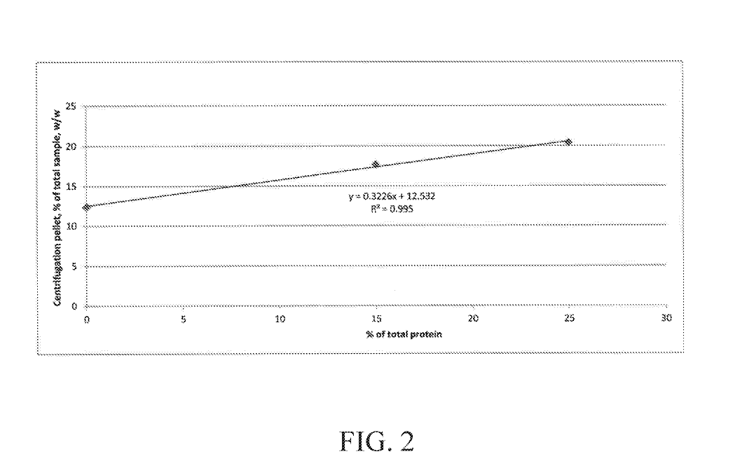

FIG. 3 is a graph showing the amount of soluble protein in three exemplary liquid nutritional compositions with variable amounts of soy protein.

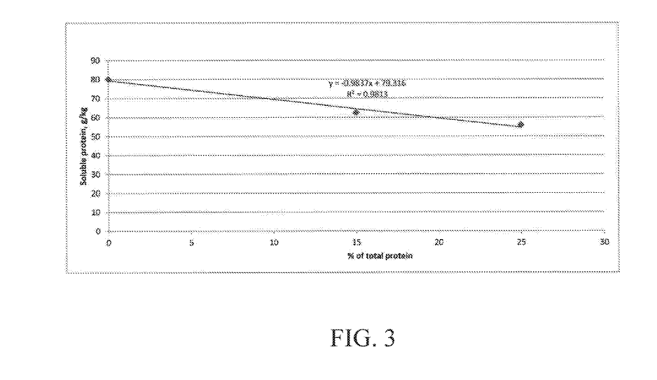

### DETAILED DESCRIPTION

The general inventive concepts will be further described hereinafter in detail with reference to the accompanying drawings and various exemplary embodiments. One of ordinary skill in the art will appreciate that these exemplary embodiments only constitute a fraction of the possible embodiments encompassed by the general inventive concepts. As such, the scope of the present disclosure is by no means limited to the exemplary embodiments set forth herein.

For the purposes of this disclosure, the following terms have the following meanings unless context dictates otherwise:

“Fat” and “oil” are used interchangeably herein to refer to lipid materials derived or processed from vegetables or animals. These terms also include synthetic lipid materials so long as such synthetic materials are suitable for oral administration to humans. As well known, such materials are normally composed of mixtures of fatty acid triglycerides, which mixtures may also contain fatty acid diglycerides and monoglycerides and even some free fatty acids.

“Nutritional composition” refers to nutritional liquids, nutritional powders which may be reconstituted to form a nutritional liquid, nutritional puddings, nutritional gels, nutritional bars, and other nutritional products all of which comprise one or more of fat, protein, and carbohydrate and are suitable for administration to or oral consumption by a human.

“Shelf stable” refers to a liquid nutritional composition that remains commercially stable after being packaged and then stored at 18-24° C. for at least 3 months.

“Total protein” in connection with the amount of protein in a particular composition means all the protein in that composition.

All percentages, parts, and ratios as used herein are by weight of the total composition, unless otherwise specified. All such weights as they pertain to listed ingredients are based on the active level and, therefore, do not include solvents or by-products that may be included in commercially available materials, unless otherwise specified.

This disclosure describes a high caloric density, high protein liquid nutritional composition with low viscosity where the protein sources include dairy and soy. It was unexpectedly found that combining dairy proteins and soy proteins, in concentrated liquid formulas, results in a product with a lower viscosity than when compared to compositions comprising all dairy proteins. In a first exemplary embodiment, a liquid nutritional composition is provided. The liquid nutritional composition comprises a source of soy protein and a source of dairy protein, wherein the liquid nutritional composition has a viscosity of 50 cps to 75 cps and a total protein content of 7 g/100 mL to 20 g/100 mL of the liquid nutritional composition.

In a second exemplary embodiment, a high caloric density liquid nutritional composition is provided. The liquid nutritional composition comprises fat, carbohydrate, and a protein content of 7 g/100 mL to 20 g/100 mL of the liquid nutritional composition. The protein comprises a source of soy protein and a source of dairy protein. The liquid nutritional composition has a caloric density of greater than 1.6 kcal/mL, a viscosity of 50 cps to 75 cps, wherein the soy protein is present in an amount of 10% to 40% of the protein content.

In general, milk proteins are more soluble than other protein sources such as, for example, soy protein. Consequently, many products containing only dairy proteins tend to have a lower viscosity and less sedimentation than products containing soy proteins. Measured solubility data for sodium caseinate, milk protein concentrate, and soy protein isolate are shown in Table 1. As can be seen in the table, the dairy proteins exhibit increased solubility over the soy proteins, when measured independently.

TABLE 1

| | Soluble protein, |
|---|---|
| Protein | % of total protein |
| Na Caseinate (3 lots) | 99.6 |
| Milk Protein Concentrate (4 lots) | 70.8 |
| Soy Protein (1 lot) | 54.1 |

### Product Form

The nutritional compositions of the present disclosure may be formulated and administered in any known or otherwise suitable oral product form. Any solid, liquid, or powder form, including combinations or variations thereof, are suitable for use herein, provided that such forms allow for safe and effective oral delivery to the individual of the essential ingredients as also defined herein.

The nutritional compositions of the present disclosure may therefore include a variety of different product forms, including any conventional or otherwise known food product form, some non-limiting examples of which include confectionary products, cereals, food condiments (e.g., spreads, powders, sauces, jams, jelly, coffee creamer or sweetener), pasta, baking or cooking materials (e.g., flour, fats or oils, butter or margarine, breading or baking mixes), salted or seasoned snacks (e.g., extruded, baked, fried), beverages (e.g., coffee, juice, carbonated beverage, non-carbonated beverage, tea), snack or meal replacement bars (e.g., Ensure™ bars, Zone Perfect™ bars, Glucerna™ bars), smoothies, breakfast cereals, cheeses, gummy products, salted or unsalted crisp snacks (e.g., chips, crackers, pretzels), dips, baked goods (e.g., cookies, cakes, pies, pastries, bread, bagels, croutons), dressings, dry mixes (e.g., mixes for muffins, cookies, waffles, pancakes, beverages), frozen desserts (e.g., ice cream, popsicles, fudge bars, crushed ice, frozen yogurt), processed meats (e.g., corn dogs, hamburgers, hotdogs, sausage, pepperoni), pizza, pudding, flavored or unflavored gelatin, refrigerated dough (e.g., cookies, bread, brownies), yogurt or yogurt-based drinks, soups, vegetable-based burgers, and popcorn-based snacks.

Specific non-limiting examples of product forms suitable for use with the nutritional compositions as disclosed herein include, for example, liquid and powdered dietary supplements, liquid and powdered human milk fortifiers, liquid and powdered infant formulas, liquid and powdered elemental and semi-elemental formulas, liquid and powdered pediatric formulas, and liquid and powdered toddler formulas.

The nutritional compositions of the present disclosure, when formulated as a dietary product form, may potentially provide either a sole source or a supplemental source of nutrition to an individual. In this context, a sole source of nutrition is one that can be administered once or multiple times each day to potentially provide an individual with all or substantially all their protein, fat, carbohydrate, mineral, and vitamin needs per day or during the intended period of administration. A supplemental source of nutrition is defined herein as a dietary source that does not provide an individual with a potentially sole source of nutrition.

### Nutritional Liquids

Nutritional liquids include both concentrated and ready-to-feed nutritional liquids. These nutritional liquids are most typically formulated as suspensions or emulsions, although other liquid forms are within the scope of the present disclosure.

Nutritional emulsions suitable for use may be aqueous emulsions comprising proteins, fats, and carbohydrates. These emulsions are generally flowable or drinkable liquids at from about 1° C. to about 25° C. and are typically in the form of oil-in-water, water-in-oil, or complex aqueous emulsions, although such emulsions are most typically in the form of oil-in-water emulsions having a continuous aqueous phase and a discontinuous oil phase.

The nutritional emulsions may be and typically are shelf stable. The nutritional emulsions typically contain up to about 95% by weight of water, including from about 50% to about 95%, also including from about 60% to about 90%, and also including from about 70% to about 85%, of water by weight of the nutritional emulsions.

The nutritional compositions, including nutritional emulsions, may have a caloric density tailored to the nutritional needs of the ultimate user. In certain exemplary embodiments, the nutritional compositions have a caloric density of at least 1.6 kcal/mL. In certain exemplary embodiments, the nutritional compositions have a caloric density of about 1.6 kcal/mL to about 2.8 kcal/mL. In certain exemplary embodiments, the nutritional compositions have a caloric density of about 1.8 kcal/mL to about 2.4 kcal/mL. In certain exemplary embodiments, the nutritional compositions have a caloric density of about 2.4 kcal/mL.

Although the serving size for the nutritional composition can vary depending upon a number of variables, a typical serving size is generally at least about 1 mL, or even at least about 2 mL, or even at least about 5 mL, or even at least about 10 mL, or even at least about 25 mL, including ranges from about 1 mL to about 500 mL, including from about 4 mL to about 250 mL, and including from about 10 mL to about 240 mL.

### Nutritional Solids

The nutritional solids may be in any solid form but are typically in the form of flowable or substantially flowable particulate compositions, or at least particulate compositions. Particularly suitable nutritional solid composition forms include spray dried, agglomerated, and/or dryblended powder compositions. The compositions can easily be scooped and measured with a spoon or similar other device and can easily be reconstituted by the intended user with a suitable aqueous liquid, typically water, to form a nutritional composition for immediate oral consumption. In this context, “immediate” use generally means within about 48 hours, most typically within about 24 hours, preferably right after reconstitution.

The nutritional compositions of this invention include ready-to-feed liquids, concentrated liquids, liquids derived from nutritional powders (reconstituted liquids), powders, and other solids such as nutritional bars. The liquid compositions may include solutions (including clear solutions), suspensions, and emulsions. The powders that are reconstituted to produce a liquid may include any flowable or scoopable particulate solid that can be diluted with water or other aqueous liquid to form a nutritional liquid prior to use.

The nutritional compositions may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit.

### Macrornutrients

Although total concentrations or amounts of the protein, fat, and carbohydrates may vary depending upon the product type (i.e., dietary supplement, medical food, human milk fortifier, infant formula, toddler formula, etc.), product form (i.e., nutritional solid, powder, ready-to-feed liquid, or concentrated liquid), and targeted dietary needs of the intended user, such concentrations or amounts most typically fall within one of the following embodied ranges, inclusive of any other essential protein, fat, and/or carbohydrate ingredients as described herein.

The amount of each macronutrient in any of the liquid nutritional compositions described herein may also be characterized in addition to, or in the alternative, as a percentage of total calories in the liquid nutritional composition as set forth in the following table. These macronutrients for liquid nutritional compositions of the present disclosure are most typically formulated within any of the caloric ranges (embodiments A-F) described in the following table (each numerical value is preceded by the term “about”).

TABLE 2

| Nutrient | | | |
|---|---|---|---|
| % Total Cal. | Embodiment A | Embodiment B | Embodiment C |
| Carbohydrate | 0-98 | 2-96 | 10-75 |
| Protein | 0-98 | 2-96 | 5-70 |
| Fat | 0-98 | 2-96 | 20-85 |
| | Embodiment D | Embodiment E | Embodiment F |
| Carbohydrate | 30-50 | 25-50 | 25-50 |
| Protein | 15-35 | 10-30 | 5-30 |
| Fat | 35-55 | 1-20 | 2-20 |

The total amount or concentration of each macronutrient in the powdered nutritional compositions of the present disclosure can vary considerably depending upon the selected composition and dietary or nutritional needs of the intended user. Additional suitable examples of macronutrient concentrations are set forth below. In this context, the total amount or concentration refers to all protein, fat, and carbohydrate sources in the powdered composition. For powdered nutritional compositions, such total amounts or concentrations are most typically and preferably formulated within any of the caloric ranges (embodiments J-L) described in the following table (each numerical value is preceded by the term “about”).

TABLE 3

| Nutrient | | | |
|---|---|---|---|
| % Total Cal. | Embodiment J | Embodiment K | Embodiment L |
| Carbohydrate | 1-85 | 30-60 | 35-55 |
| Fat | 5-70 | 20-60 | 25-50 |
| Protein | 2-75 | 5-50 | 7-40 |

### Protein

The nutritional compositions according to the general inventive concepts include at least one protein or source of protein. Suitable sources of protein for use herein include any protein or protein source that is suitable for use in an oral nutritional composition and is compatible with the essential elements and features of such products. The amount of protein present in the nutritional composition can vary widely and may be based on the particular needs of the intended consumer or the intended product form.

One way to express the amount of protein present in the nutritional composition is the amount of protein per unit volume of the nutritional composition as a whole. If the nutritional composition is a nutritional powder, the total amount of protein may refer to the amount of protein (per volume) present in the nutritional composition after reconstitution, as directed. The same applies to the other ingredients of the nutritional compositions, including fat and carbohydrate, which are discussed in more detail below.

In certain exemplary embodiments, protein is included in the liquid nutritional composition in a total protein content of 7 g/100 mL to 20 g/100 mL of the nutritional composition. In certain exemplary embodiments, protein is included in the liquid nutritional composition in a total protein content of 7 g/100 mL to 15 g/100 mL of the nutritional composition. In certain exemplary embodiments, protein is included in the liquid nutritional composition in a total protein content of 10 g/100 mL to 20 g/100 mL of the nutritional composition. In certain exemplary embodiments, protein is included in the liquid nutritional composition in a total protein content of 10 g/100 mL to 15 g/100 mL of the nutritional composition. In certain exemplary embodiments, protein is included in the liquid nutritional composition in a total protein content of 10 g/100 mL to 12 g/100 mL of the nutritional composition.

The protein in the nutritional compositions may be characterized by the amount of soluble protein in the nutritional composition. In certain exemplary embodiments, soluble protein is present in an amount of less than 70 g/kg of the liquid nutritional composition.

Traditionally, dairy proteins have been the proteins of choice for making a wide variety of different nutritional compositions. For various reasons, efforts have been undertaken to replace some or all of these milk proteins with alternative protein sources, including vegetable proteins. The problem, however, is that other proteins may have a negative effect on the desirable properties that nutritional compositions exhibit including flavor, odor, viscosity (in the case of liquids), texture, short term stability, long term (shelf) stability, and nutritional value. In accordance with the general inventive concepts, it has been found that particular combinations of dairy proteins and soy proteins can be selected to formulate such compositions without adversely affecting their taste, nutritional value, and other hedonic properties including appearance and mouthfeel (creaminess, viscosity).

### Dairy Protein

In certain exemplary embodiments, the nutritional compositions contain a substantial amount of milk or dairy protein. Dairy proteins are commercially available in a variety of different forms. Examples include milk protein isolates, milk protein concentrates, caseinates, whey isolates, whey concentrates, milk, non-fat dry milk, and condensed skim milk, micellar proteins such as micellar caseins and micellar milk protein concentrate all of which are suitable for use in accordance with the general inventive concepts. In some forms, the natural distribution of whey and casein is preserved. In other forms, the whey or the casein is concentrated relative to the other.

Whey protein is commercially available as liquid whey or in powder form as whey protein isolate (WPI) or whey protein concentrate (WPC). All have an elevated whey protein/casein ratio relative to whole milk.

Casein separates from milk when milk is curdled, a process commonly carried out in the manufacturing of cheese, and is commonly called caseinate, having lost its typical micellar structure. Casein is most commonly bound to calcium (Ca²⁺) and sodium (Na⁺) since all of these ions are found naturally in milk, or even potassium (K⁺) or magnesium (Mg²⁺), and tends to stick to the casein during the extraction process.

Two milk protein sources in which the natural distribution of whey and casein is essentially preserved are milk protein concentrate (MPC) and milk protein isolate (MPI). MPC and MPI are products in which a substantial amount of the water and fat in whole milk have been removed. MPIs are further characterized in that a significant portion of the lactose has also been removed. As a result, the concentration of milk proteins in an MPI is normally greater than that found in a typical MPC, although this is not always the case.

In certain exemplary embodiments, a majority of the protein in the nutritional composition is dairy protein. In certain exemplary embodiments, dairy protein is provided in an amount of at least 60% of the total protein in the nutritional composition. In certain exemplary embodiments, dairy protein is provided in an amount of 60% to 90% of the total protein in the nutritional composition. In certain exemplary embodiments, dairy protein is provided in an amount of 70% to 90% of the total protein in the nutritional composition. In certain exemplary embodiments, dairy protein is provided in an amount of 60% to 85% of the total protein in the nutritional composition. In certain exemplary embodiments, dairy protein is provided in an amount of 70% to 85% of the total protein in the nutritional composition.

### Soy Protein

In certain exemplary embodiments, the nutritional compositions also contain substantial amounts of soy protein. Both intact soy protein and hydrolyzed soy protein sources can be used. Soy protein is a vegetable protein that contains most essential amino acids in a relatively high proportion. Soy protein can be divided into different categories according to its production method. For the purposes of this disclosure, “soy protein concentrate” (SPC) will be understood to be a generic term referring to products which are basically soybean without the water soluble carbohydrates and which contain about 60% to 90% by weight or more soy protein. More commonly, these products contain 60% to 85% by weight soy protein, and even more typically 70% to 80% soy protein. Meanwhile, “soy protein isolate” (SPI) will be understood to mean a type of SPC which contains about 85% to 90% protein. SPI is the most refined form of soy protein and is mainly used in meat products to improve texture and eating quality.

Several soy protein sources are readily available to the skilled person, for example, from The Solae Company of St. Louis, Mo., USA, and the Arthur Daniels Midland Company of Decatur, Ill., USA.

In certain exemplary embodiments, soy protein is provided in an amount of less than 40% of the total protein in the nutritional composition. In certain exemplary embodiments, soy protein is provided in an amount of 10% to 40% of the total protein in the nutritional composition. In certain exemplary embodiments, soy protein is provided in an amount of 10% to 30% of the total protein in the nutritional composition. In certain exemplary embodiments, soy protein is provided in an amount of 15% to 40% of the total protein in the nutritional composition. In certain exemplary embodiments, dairy protein is provided in an amount of 15% to 30% of the total protein in the nutritional composition.

In certain exemplary embodiments, the nutritional compositions may include one or more additional sources of protein. Non-limiting examples of suitable additional proteins or sources thereof for use in the nutritional compositions include hydrolyzed, partially hydrolyzed, or non-hydrolyzed proteins or protein sources, which may be derived from any known or otherwise suitable source such as animal (e.g., meat, fish), cereal (e.g., rice, corn), vegetable (e.g., pea), or combinations thereof.

### Fat

The nutritional compositions according to the general inventive concepts include fat or a source of fat. Suitable sources of fat for use herein include any fat or fat source that is suitable for use in an oral nutritional composition and is compatible with the essential elements and features of such products. The amount of fat present in the nutritional composition can vary widely and may be based on the particular needs of the intended consumer or the intended product form.

Non-limiting examples of suitable fats or sources thereof for use in the nutritional compositions described herein include coconut oil, fractionated coconut oil, soybean oil, corn oil, olive oil, safflower oil, high oleic safflower oil, oleic acids, MCT oil (medium chain triglycerides), sunflower oil, high oleic sunflower oil, palm and palm kernel oils, palm olein, canola oil, marine oils, fish oils, fungal oils, algae oils, cottonseed oils, and combinations thereof.

In certain exemplary embodiments, fat is present in the liquid nutritional composition in a total amount of 4 g/100 mL to 16 g/100 mL of the nutritional composition. In certain exemplary embodiments, fat is present in the liquid nutritional composition in an amount of 4 g/100 mL to 12 g/100 mL of the nutritional composition. In certain exemplary embodiments, fat is present in the liquid nutritional composition in an amount of 4 g/100 mL to 10 g/100 mL of the nutritional composition. In certain exemplary embodiments, fat is present in the liquid nutritional composition in an amount of 5 g/100 mL to 12 g/100 mL of the nutritional composition. In certain exemplary embodiments, fat is present in the liquid nutritional composition in an amount of 8 g/100 mL to 10 g/100/mL of the nutritional composition.

### Carbohydrate

The nutritional compositions according to the general inventive concepts may further comprise carbohydrates or a source of carbohydrates that are suitable for use in an oral nutritional composition and are compatible with the essential elements and features of such products. The amount of carbohydrate present in the nutritional composition can vary widely and may be based on the particular needs of the intended consumer or the intended product form.

Non-limiting examples of a source of carbohydrate suitable for use in the nutritional compositions described herein include maltodextrin, hydrolyzed or modified starch or cornstarch, glucose polymers, corn syrup, corn syrup solids, rice-derived carbohydrates, sucrose, glucose, fructose, lactose, high fructose corn syrup, honey, sugar alcohols (e.g., maltitol, erythritol, sorbitol), isomaltulose, sucromalt, pullulan, potato starch, slowly-digested carbohydrates, dietary fibers (e.g., oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low and high methoxy pectin, cereal beta-glucans (e.g., oat beta-glucan, barley beta-glucan), carrageenan, and psyllium), Fibersol™, other resistant starches, and combinations thereof.

In certain exemplary embodiments, carbohydrate is present in the liquid nutritional composition in a total amount of 8 g/100 mL to 50 g/100 mL of the nutritional composition. In certain exemplary embodiments, carbohydrate is present in the liquid nutritional composition in an amount of 8 g/100 mL to 40 g/100 mL of the nutritional composition. In certain exemplary embodiments, carbohydrate is present in the liquid nutritional composition in an amount of 8 g/100 mL to 30 g/100 mL of the nutritional composition. In certain exemplary embodiments, carbohydrate is present in the liquid nutritional composition in an amount of 20 g/100 mL to 40 g/100 mL of the nutritional composition. In certain exemplary embodiments, carbohydrate is present in the liquid nutritional composition in an amount of 20 g/100 mL to 28 g/100 mL, including about 28 g/100 mL of the nutritional composition.

### Optional Ingredients

The nutritional compositions of the present disclosure may further comprise other optional components that may modify the physical, chemical, aesthetic, or processing characteristics of the products or serve as pharmaceutical or additional nutritional components when used in the targeted population. Many such optional ingredients are known or otherwise suitable for use in medical food or other nutritional products or pharmaceutical dosage forms and may also be used in the compositions herein, provided that such optional ingredients are safe for oral administration and are compatible with the essential and other ingredients in the selected product form.

Non-limiting examples of such optional ingredients include preservatives, emulsifying agents, buffers, fructooligosaccharides, galactooligosaccharides, polydextrose, and other prebiotics, probiotics, pharmaceutical actives, additional nutrients as described herein, colorants, flavors, thickening agents and stabilizers, lubricants, and so forth.

The nutritional compositions may further comprise a sweetening agent, preferably including at least one sugar alcohol such as maltitol, erythritol, sorbitol, xylitol, mannitol, isolmalt, and lactitol, and also preferably including at least one artificial or high potency sweetener such as acesulfame K, aspartame, sucralose, saccharin, stevia, and tagatose. These sweetening agents, especially as a combination of a sugar alcohol and an artificial sweetener, are especially useful in formulating liquid beverage embodiments of the present disclosure having a desirable favor profile. These sweetener combinations are especially effective in masking undesirable flavors sometimes associated with the addition of vegetable proteins to a liquid beverage. Optional sugar alcohol concentrations in the nutritional composition may range from at least 0.01%, including from about 0.1% to about 10%, and also including from about 1% to about 6%, by weight of the nutritional composition. Optional artificial sweetener concentrations may range from about 0.01%, including from about 0.05% to about 5%, also including from about 0.1% to about 1.0%, by weight of the nutritional composition.

A flowing agent or anti-caking agent may be included in the nutritional compositions as described herein to retard clumping or caking of the powder over time and to make a powder embodiment flow easily from its container. Any known flowing or anti-caking agents that are known or otherwise suitable for use in a nutritional powder or product form are suitable for use herein, non-limiting examples of which include tricalcium phosphate, silicates, and combinations thereof. The concentration of the flowing agent or anti-caking agent in the nutritional composition varies depending upon the product form, the other selected ingredients, the desired flow properties, and so forth, but most typically range from about 0.1% to about 4%, including from about 0.5% to about 2%, by weight of the nutritional composition.

A stabilizer may also be included in the nutritional compositions. Any stabilizer that is known or otherwise suitable for use in a nutritional composition is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the nutritional composition.

The nutritional compositions may further comprise any of a variety of other vitamins or related nutrients, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof.

The nutritional compositions may further comprise any of a variety of other additional minerals, non-limiting examples of which include calcium, phosphorus, magnesium, iron, zinc, manganese, copper, sodium, potassium, molybdenum, chromium, chloride, and combinations thereof.

Viscosity is a well-known property of liquid compositions, including liquid nutritional compositions. The viscosities of the nutritional compositions can be easily determined using a Brookfield viscometer, No. 1 Spindle. In certain exemplary embodiments, the nutritional composition has a viscosity of 50 cps to 75 cps. In certain exemplary embodiments, the nutritional composition has a viscosity of 60 cps to 75 cps.

### Examples

The following examples illustrate specific embodiments and/or features of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the product, unless otherwise specified.

To illustrate the general inventive concepts more thoroughly, three different liquid nutritional compositions were prepared using the formulations provided in Table 4.

TABLE 4

| Ingredient Water | Sample 1 | Sample 2 | Sample 3 |
|---|---|---|---|
| Ingredient Water | Q.S. | Q.S. | Q.S. |
| Corn Syrup | 282 | 281 | 281 |
| Milk Protein Concentrate | 83.7 | 83.7 | 94.9 |
| Canola oil | 33.7 | 33.5 | 33.5 |
| High Oleic Safflower Oil | 33.7 | 33.5 | 33.5 |
| Sodium Caseinate Hydrolyzed | 24.9 | — | — |
| Soy Protein Isolate | — | 26.1 | 15.6 |
| Sucrose | 19.5 | 19.4 | 19.4 |
| Corn Oil | 17.0 | 16.9 | 16.9 |
| Soy Lecithin | 3.13 | 3.11 | 3.12 |
| Potassium Chloride | 2.10 | 2.11 | 2.11 |
| 45% KOH | 2.10 | 2.10 | 2.10 |
| Calcium Citrate | 2.00 | 1.83 | 1.22 |
| Flavoring | 2.00 | 1.00 | 1.00 |
| Choline Chloride | 0.960 | 0.960 | 0.960 |
| Magnesium Phosphate | 0.826 | 0.777 | 0.753 |
| Dibasic | | | |
| Ascorbic Acid | 0.350 | 0.350 | 0.350 |
| FSMP Vitamin premix | 0.315 | 0.315 | 0.315 |
| Avicel CL611 | 0.250 | 0.250 | 0.250 |
| UTM/TM premix | 0.179 | 0.179 | 0.179 |
| 45% KOH | 0.135 | 0.135 | 0.135 |
| Ferrous Sulfate | 0.115 | 0.0477 | 0.0477 |
| Vitamin ADEK premix | 0.105 | 0.105 | 0.105 |
| Liquid Sucralose (25%) | 0.0710 | 0.0709 | 0.0708 |
| Potassium Citrate | 0.0439 | 0.0439 | 0.0439 |
| Acesulfame Potassium | 0.0122 | 0.0122 | 0.0122 |
| Cupric Sulfate | 0.0080 | 0.00224 | 0.00224 |
| Thiamine Hydrochloride, | 0.0009 | 0.0009 | 0.0009 |
| USP | | | |
| Potassium Iodide | 0.000423 | 0.000423 | 0.000423 |

Table 5 shows the difference in the measured viscosity of concentrated liquid samples containing 10.2 g protein per 100 mL with different protein systems. When the sodium caseinate is removed from the protein system and replaced with soy protein isolate, there was an unexpected decrease in finished product viscosity.

TABLE 5

| | | 50 s−1 | 60 s−1 | 100 s−1 | 400 s−1 |
|---|---|---|---|---|---|
| Sample | Protein System | (mPa) | (mPa) | (mPa) | (mPa) |
| 1 | 75% MPC 4861 | 95.23 | 95.0 | 91.53 | 82.46 |
| | 25% NaCaseinate | | | | |
| 2 | 75% MPC 4861 | 72.10 | 71.4 | 70.34 | 66.01 |
| | 25% SPI ProFam | | | | |
| | 825 | | | | |
| 3 | 85% MPC 4861 | 68.89 | 68.2 | 66.60 | 61.26 |
| | 15% SPI ProFam | | | | |
| | 825 | | | | |

Table 6 shows the measured color of concentrated liquid samples 1-3 containing 10.2 g protein per 100 mL. When sodium caseinate is replaced with soy protein isolate, there is a noticeable difference in color (as measured by the Hunter Color Scale) when the level of soy protein is at least 25% of the protein system.

TABLE 6

Hunter Color

| Sample | Protein System | L | a | b |
|---|---|---|---|---|
| 1 | 75% MPC 4861 | 66.89 | 3.19 | 23.25 |
| | 25% Na Caseinate | | | |
| 2 | 75% MPC 4861 | 68.30 | 2.24 | 21.92 |
| | 25% SPI ProFam | | | |
| | 825 | | | |
| 3 | 85% MPC 4861 | 65.82 | 2.89 | 21.79 |
| | 15% SPI ProFam | | | |
| | 825 | | | |

Samples 1-3 were centrifuged, and the supernatant was tested for soluble protein and soluble calcium. The results of these tests are presented in Table 7. The lower soluble protein and soluble calcium levels seen in the variables with added soy protein (Samples 1-3) may indicate that the insoluble protein is forming a complex with the soluble calcium and contributing to the measured changes in viscosity between the different formulations.

TABLE 7

| Sample | 1 | 2 | 3 |
|---|---|---|---|
| Protein System | 75% MPC, | 75% MPC, | 85% MPC, |
| | 25% Na | 25% ProFam | 15% ProFam |
| | Caseinate | 825 | 825 |
| Centrifugation | 12.4% | 20.4% | 17.7% |
| pellet, % w/w | | | |
| Soluble protein, | 80.1 | 55.9 | 62.6 |
| g/kg | | | |
| Soluble calcium, | 962 | 710 | 549 |
| mg/kg | | | |

In accordance with the general inventive concepts, products containing at least 10.2 g protein per 100 mL, were prepared using a combination of soy protein and dairy protein, without resulting in the thick mouthfeel that would be expected of such combinations.

The various embodiments of the nutritional compositions of the present disclosure may also be substantially free of any optional or selected essential ingredient or feature described herein, provided that the remaining nutritional composition still contains all of the required ingredients or features as described herein. In this context, and unless otherwise specified, the term “substantially free” means that the selected nutritional composition contains less than a functional amount of the optional ingredient, typically less than about 1%, including less than about 0.5%, including less than about 0.1%, and also including zero percent, by weight of such optional or selected essential ingredient.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

The nutritional compositions and methods may comprise, consist of, or consist essentially of the essential elements of the compositions and methods as described herein, as well as any additional or optional element described herein or otherwise useful in nutritional composition applications.

Although the present disclosure has been described with reference to specific embodiments, it should be understood that the limitations of the described embodiments are provided merely for purpose of illustration and are not intended to limit the present invention and associated general inventive concepts. Instead, the scope of the present invention is defined by the appended claims, and all variations and equivalents that fall within the range of the claims are intended to be embraced therein. Thus, other embodiments than the specific exemplary ones described herein are equally possible within the scope of these appended claims.

1. A liquid nutritional composition comprising:
a source of soy protein; and
a source of dairy protein;
wherein the liquid nutritional composition has a viscosity of 50 cps to 75 cps and a total protein content of 7 g to 20 g per 100 mL of the liquid nutritional composition.

2. The liquid nutritional composition of claim 1, further comprising at least one of fat and carbohydrate.

3. The liquid nutritional composition of claim 1 further comprising fat, wherein the fat is present in an amount of 4 g to 16 g per 100 mL of the liquid nutritional composition.

4. The liquid nutritional composition of claim 1, further comprising carbohydrate, wherein the carbohydrate is present in an amount of 8 g to 50 g per 100 mL of the liquid nutritional composition.

5. The liquid nutritional composition of claim 1, wherein the liquid nutritional composition has a caloric density of at least 1.6 kcal per mL of the liquid nutritional composition.

6. The liquid nutritional composition of claim 1, wherein the liquid nutritional composition has a caloric density of 1.6 kcal to 2.8 kcal per mL of the liquid nutritional composition.

7. The liquid nutritional composition of claim 1, wherein the soy protein comprises 10% to 40% of the total protein content.

8. The liquid nutritional composition of claim 1, wherein the soy protein comprises 15% to 30% of the total protein content.

9. The liquid nutritional composition of claim 1, wherein the soy protein comprises at least one of soy protein concentrate and soy protein isolate.

10. The liquid nutritional composition of claim 1, wherein the dairy protein comprises at least one of milk protein concentrate, sodium caseinate, and calcium caseinate.

11. The liquid nutritional composition of claim 1, wherein the total protein content is 10 g to 20 g per 100 mL of the liquid nutritional composition.

12. The liquid nutritional composition of claim 1, wherein the liquid nutritional composition has a viscosity of 60 cps to 75 cps.

13. A high caloric density liquid nutritional composition comprising
fat;
carbohydrate; and
a protein content of 7 g to 20 g per 100 mL of the liquid nutritional composition, the protein comprising:
a source of soy protein; and
a source of dairy protein;
wherein the liquid nutritional composition has a caloric density of greater than 1.6 kcal/mL, a viscosity of 50 cps to 75 cps; and
wherein the soy protein constitutes 10% to 40% of the protein content.

14. The high caloric density liquid nutritional composition of claim 13, wherein the soy protein constitutes 15% to 30% of the protein content.

15. The high caloric density liquid nutritional composition of claim 13, wherein the soy protein is soy protein isolate.

16. The high caloric density liquid nutritional composition of claim 13, wherein the protein content is 10 g to 20 g per 100 mL of the liquid nutritional composition.

17. The high caloric density liquid nutritional composition of claim 13, wherein the caloric density is 1.6 kcal to 2.8 kcal per mL of the liquid nutritional composition.

18. The high caloric density liquid nutritional composition of claim 13, wherein soluble protein is present in an amount of less than 70 g per kg of the liquid nutritional composition.

19. The high caloric density liquid nutritional composition of claim 13, wherein the fat is present in an amount of 4 g to 16 g per 100 ml of the liquid nutritional composition.

20. The high caloric density liquid nutritional composition of claim 13, wherein the carbohydrate is present in an amount of 8 g to 50 g per 100 mL of the liquid nutritional composition.
